(19) United States
(12) Patent Application Publication
(10) Pub. No.: US 2009/0139637 A1
(43) Pub. Date: Jun. 4, 2009

(54) NOISE-SUPPRESSING AND HIGHLY ABRASION-RESISTANT TAPE INTENDED ESPECIALLY FOR THE BANDAGING OF CABLE HARNESSES IN MOTOR VEHICLES

(75) Inventors: Patrik Kopf, Hamburg (DE); Andreas Wahlers-Schmidlin, Guderhandviertel (DE); Daniel Wienke, Hamburg (DE)

Correspondence Address: NORRIS, MCLAUGHLIN & MARCUS, PA, 875 THIRD AVENUE, 18TH FLOOR, NEW YORK, NY, 10022, US

(73) Assignee: tesa AG, Hamburg (DE)

(21) Appl. No.: 12/323,734

(22) Filed: Nov. 26, 2008

(30) Foreign Application Priority Data
Dec. 4, 2007 (DE) 10 2007 058 460.3

(51) Int. Cl. B29C 63/10; B32B 5/26

(52) U.S. Cl. 156/187; 442/381; 442/382; 442/383

(57) ABSTRACT

Noise-suppressing and highly abrasion-resistant tape, preferably for wrapping elongated products such as, in particular, leads or cable looms, comprising a backing which is composed at least of three layers, specifically a first outer layer A, a second outer layer B, and an interlayer C, which is located between outer layers A and B and is firmly connected at least in sections to the outer layers A and B. The outer layer A is composed of a stitchbonded nonwoven, the outer layer B is composed of a nonwoven, and the interlayer C is composed of a film which is coated on both sides with a viscoelastic adhesive.

The invention relates to a noise-suppressing and highly abrasion-resistant tape, preferably for wrapping elongated products such as, in particular, leads or cable looms, comprising a backing which is composed at least of three layers, specifically a first outer layer A, a second outer layer B, and an interlayer C, which is located between outer layers A and B and is firmly connected at least in sections to the outer layers A and B, and to which preferably, at least on one side, a pressure-sensitive adhesive coating is applied. The invention further relates to the use of the tape and also to a cable harness wrapped with the tape of the invention.

In many sectors of industry, bundles composed of a multiplicity of electrical leads are wrapped either before installation or when already mounted, in order to reduce the space taken up by the bundle of leads, by means of bandaging, and also to obtain protective functions. With film-backed adhesive tapes, a certain protection against ingress of fluid is achieved, with airy and bulky adhesive tapes based on thick nonwovens or foams as backings, insulating properties are obtained; and when stable, abrasion-resistant backing materials are used, a protective function against scuffing and rubbing is obtained.

DE 298 23 462 U1 discloses an adhesive tape having a two-layer backing, the lower layer of which is coated with an adhesive. The upper layer of the backing is composed of knitted velour, while the lower is formed by a synthetic fiber web. Both layers are adhesively bonded at least in regions, more particularly to a thermoplastic web. As the skilled person is aware, knitted velour is complicated to produce and is expensive.

DE 101 49 975 A1 describes a two-layer construction of a backing in an adhesive tape, namely a textile layer plus a film, preferably a PVC film, which is calendered to the textile layer. The adhesive is an acrylate composition. With this construction it is not possible to achieve high abrasion resistance.

EP 1 723 210 A1 discloses, as a backing, a topmost outer layer A, firmly connected to a second layer C over the entire area of the outer layer A, more particularly by stitching/needling, the outer layer A being composed of a velour, scrim, woven fabric or formed-loop knit, in particular a woven PET filament fabric or a woven polyamide fabric and the layer C being composed of a porous sheet-like structure such as a textile having an open but stable three-dimensional structure, or of a foam or of a foamed film. The layer C is bulky, 0.2 to 3 mm thick and absorbs the abrasion energy and ensures noise suppression. On the layer C, and more particularly on the side opposite the layer A, there is a further layer B of velour, woven fabric or formed-loop knit. However, thick interlayers such as C are thick in the applied state. Furthermore, needled composites (such as the layers A/C) are expensive. In addition, nonwovens of the Kunit and Multiknit types are very expensive, making an assembly of this kind virtually unaffordable, and in their applied state are too thick.

WO2005/084944 A2 describes as a backing material a topmost layer of woven or knitted fabric and a bottommost layer of woven or knitted fabric, between which there is an interlayer comprising viscoelastic adhesive or a double-sided adhesive tape. Nonwovens are mentioned in particular as an interlayer for the purpose of achieving noise suppression. Noise suppression cannot be achieved with a viscoelastic adhesive alone. Woven fabrics do not effect suppression, and knitted fabrics are very expensive as insulating materials. Nonwovens are cost-effective and noise-suppressing. The film layer in the interlayer is used not to increase the abrasion resistance but instead as a barrier layer or suppression layer.

EP 1 063 747 A1 shows two nonwovens, connected to one another, as an adhesive tape backing. Two nonwovens, however, do not ensure particularly high abrasion values.

The abrasion resistance is a measure of the scuff resistance of adhesive tapes. An established method of determining the abrasion resistance of protection systems in vehicle electrics is the international standard ISO 6722, Section 9.3 “Scrape abrasion test” (April 2002 edition). In this test the test specimen (for example, the insulated copper lead or else the wrapping tape adhered to a metal mandrel) is exposed to a thin steel wire with defined scrape geometries and under a defined weight load, until the protective sheath has been rubbed through and as a result of short circuiting, the counter which runs at the same time comes to a stop.

Unless indicated otherwise, all details relating to abrasion resistance refer to this ISO 6722 method. For this purpose the adhesive tape is adhered in a single ply in the longitudinal direction on a metal mandrel 10 mm in diameter; the scraping motion takes place essentially on the adhesive tape under a weight load of 7 N. The rubbing body used is a steel wire complying with ISO 8458-2, 0.45 mm in diameter. The abrasion resistance parameter reported is the number of scrapes until short circuiting. In cases of very high abrasion resistance, it has been found to be appropriate to measure the adhesive tape on a metal mandrel with a diameter of 5 mm as well. This makes it possible also to simulate abrasion resistance with respect to relatively sharp objects such as, for example, a metal edge.

The noise suppression effect is a measure of the noise reduction effect of adhesive tapes. The physical measurement of the noise suppression effect is made in accordance with the method described in detail in DE 100 39 982 A1. This is a measurement methodology which is established in the motor vehicle industry, as is specified, for example, in standards including the BMW standard GS 95008-3 (May 2000 edition).

### BRIEF DESCRIPTION OF THE DRAWINGS

The invention will now be summarized and later described in greater detail with references to the drawings, wherein:

FIG. 1 shows the construction of a measuring apparatus in side elevation for making a measurement pursuant to the measurement method of BMW standard GS 95008-3 from May 2000,

FIG. 2 shows the same construction in horizontal elevation,

FIG. 3a shows the self-adhesive tape of the invention in side-on section,

FIG. 3b shows the self-adhesive tape of the invention in a first advantageous embodiment, in side-on section,

FIG. 3c shows the self-adhesive tape of the invention in a second advantageous embodiment, in side-on section,

FIG. 3d shows the self-adhesive tape of the invention in a third advantageous embodiment, in side-on section, and

FIG. 4 shows the use of the self-adhesive tape of the invention in association with the wrapping of cables, i.e. a cable harness.

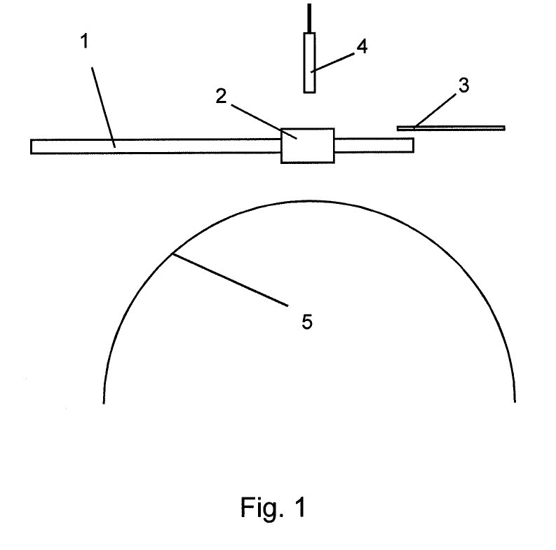

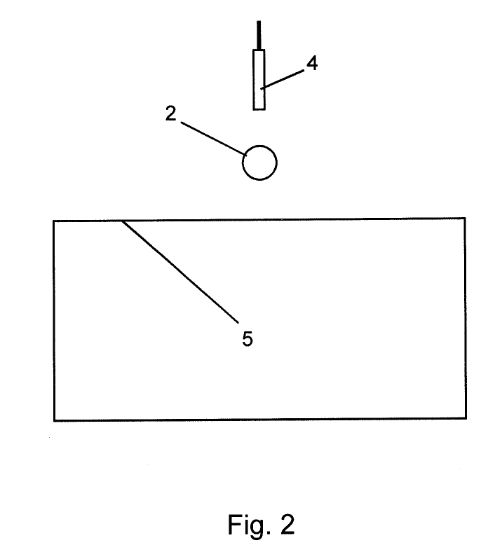

Detailed below in conjunction with FIGS. 1 and 2 is the measurement method of BMW standard GS 95008-3 from May 2000. With this measurement method, a defined steel rod (1) with a diameter of 8 mm is wrapped with the test specimen (2)—or adhesive tape—in such a way as to produce lever lengths of 220 mm and 150 mm. The wrapped steel rod (1) is dropped onto an aluminium sheet (5) until the stop (3) is reached, over the drop height, and with a weight of approximately 16 g. The aluminium sheet (5), which in the unformed state measures 350×190×0.3 [mm], is arranged in the form of a half-barrel beneath the test specimen (2), producing a span of 290 mm. The overall sound outcome is detected and recorded by means of a microphone (4) disposed over the test arrangement, in a frequency range of 20 to 12 500 Hz, for example, using a commercial noise meter, of type 2226 from Bruel & Kjaer, for example. Particularly relevant for the human ear are frequencies in the range from 2000 to 5000 Hz. The suppression is reported as the difference between blank value with unwrapped steel rod and the respective measurement value in dB(A).

In addition to the measurement methods stated, the adhesive tapes are classified in accordance with the motor vehicle testing directive LV 312 (January 2006 edition) into abrasion classes (class A, low abrasion resistance to class E, very high abrasion resistance) and also into noise suppression classes (class A, low noise suppression to class E, very high noise suppression; measurement takes place in dB (A)).

The following table offers an overview of the aforementioned classification:

| | | Number of scrapes | dB(A) attenuation |
|---|---|---|---|
| Class | Classification | requirement | requirement |
| A | none/low | <100 | 0 to <2 |
| B | low | 100 to 499 | >2 to <5 |
| C | moderate | 500 to 999 | >5 to <10 |
| D | high | 1000 to 4999 | >10 to <15 |
| E | very high | >5000 | >15 |

It is an object of the invention to achieve a marked improvement on the prior art and to provide a tape which combines the possibility for bandaging individual leads to form cable looms with a high level of protection from mechanical damage by scuffing and rubbing on sharp edges, burrs or weld spots, and at the same time exhibits fairly high noise suppression.

This object is achieved by means of a tape as described hereinbelow. Additionally embraced by the concept of the invention are the use of the tape of the invention and also a cable harness wrapped with the tape.

The invention accordingly provides a noise-suppressing and highly abrasion-resistant tape, preferably for wrapping elongated products such as, in particular, leads or cable looms, comprising a backing which is composed at least of three layers, specifically
a first outer layer A,
a second outer layer B,
an interlayer C, which is located between outer layers A and B and is firmly connected at least in sections to the outer layers A and B,
   where
the outer layer A is composed of a stitchbonded nonwoven,
the outer layer B is composed of a nonwoven, and
the interlayer C is composed of a film which is coated on both sides with a viscoelastic adhesive.

A stitchbonded nonwoven is composed of a fiber web or spunbonded web, preferably cross-laid, which is consolidated either with the aid of threads, in a stitchbonding machine of the Maliwatt type, or by interlooping of the fibers, in a stitchbonding machine of the Malivlies type.

According to one first advantageous embodiment of the invention an adhesive coating is applied at least on one side on the backing, preferably on the outer layer B, and so the adhesive tape is single-sided.

The general expression “adhesive tape” embraces, within the meaning of this invention, all sheet-like structures such as two-dimensionally extended films or film sections, tapes with extended length and limited width, tape sections, die cuts, labels and the like.

With further preference the adhesive coating is a self-adhesive coating, based in particular on rubber, acrylate or silicone.

The coat weight of the adhesive on the backing advantageously spans the range between 20 to 100 g/m².

The adhesive can be applied in the longitudinal direction of the adhesive tape in the form of a stripe whose width is lower than that of the adhesive tape's backing. Depending on the specific use, it is also possible for the backing material to be coated with two or more parallel stripes of the adhesive. The position of the stripe on the backing is arbitrary, although an arrangement directly at one of the edges of the backing is preferred.

According to a further advantageous embodiment of the invention, the film in the interlayer C is composed of polymers such as PVC, polyethylene, polypropylene, polyester, polyurethane or polyamide.

The film in the interlayer C preferably has a thickness of 5 to 150 μm, more particularly 12 to 50 μm.

The viscoelastic adhesive on the double-sidedly coated films is preferably a self-adhesive based on natural rubber, polyacrylates, synthetic rubber or silicones, preferably based on polyacrylate.

Viscoelasticity is a term used for the time-, temperature- and frequency-dependent elasticity of polymeric melts or solids (plastics). Viscoelasticity is marked by a partly elastic, partly viscous behavior. Following removal of an external force, the relaxation of the material is incomplete; the energy that remains is dissipated in the form of flow events (retardation).

In accordance with the invention the outer layer A is composed of a stitchbonded nonwoven and the outer layer B is composed of a nonwoven, the term “nonwoven” encompassing at least textile sheet-like structures according to EN 29092 (1988) and also stitchbonded webs and similar systems.

Nonwovens suitable for the outer layer B include, in particular, staple fiber webs, but also filament webs, meltblown webs and spunbonded webs, all of which are preferably consolidated additionally. Possible consolidation methods known for nonwovens include mechanical, thermal and chemical consolidation. Whereas, in the case of mechanical consolidation, the fibers are usually held together purely mechanically by entangling of the individual fibers (by means of air jets or water jets), by interlooping of fiber bundles or by stitched incorporation of additional threads, it is possible by thermal and by chemical methods to obtain adhesive (with binder) or cohesive (binder-free) fiber-fiber bonds. Given appropriate formulation and an appropriate process regime, these bonds may be restricted exclusively or at least predominantly, to the fiber nodal points, so that a stable, three-dimensional network is formed while retaining the loose open structure in the web.

Also particularly advantageous is a staple fiber web which is mechanically preconsolidated in the first step or is a wet-laid web laid hydrodynamically, between 2% and 50% of the fibers of the web being fusible fibers, more particularly between 5% and 40% of the fibers of the web. A web of this kind is characterized in that the fibers are laid wet or, for example, a staple fiber web is preconsolidated by the formation of loops from fibers of the web or by needling, stitching or air-jet and/or water-jet treatment. In a second step, thermofixing takes place, with the strength of the web being increased again by the complete or partial melting of the fusible fibers. The web backing may also be consolidated without binders, by means, for example, of hot embossing with structured rollers, in which case pressure, temperature, dwell time and the embossing geometry can be used to control properties such as strength, thickness, density, flexibility and the like.

The webs employed mandatorily for the outer layer A, and in possible embodiments for the outer layer B, are webs which have been consolidated by overstitching with separate threads or by interlooping.

Consolidated webs of this kind are produced for example on stitchbonding machines of the “Malivlies” type from Karl Mayer, formerly Malimo, and can be obtained from sources including the company Techtex GmbH. A Malivlies is characterized in that a cross-laid web is consolidated by the formation of loops from fibers of the web. The nonwoven used may also be a web of the Kunit or Multiknit type. A Kunit web is characterized in that it originates from the processing of a longitudinally oriented fiber web to produce a sheet-like structure which has loops on one side and on the other loop feet or pile fiber folds, but possesses neither threads nor prefabricated sheet-like structures. A web of this kind too has been produced, for a relatively long time, on—for example—stitchbonding machines of the “Kunitvlies” type from Karl Mayer. A further characterizing feature of this web is that, as a longitudinal-fiber web, it is able to absorb high tensile forces in the longitudinal direction. The characteristic feature of a Multiknit web relative to the Kunit web is that the web is consolidated on both the top and bottom sides by virtue of the double-sided needle punching. Finally, stitchbonded webs are also suitable. A stitchbonded web is formed from a nonwoven material having a large number of stitches extending parallel to one another. These stitches are brought about by the incorporation, by stitching or knitting of continuous textile threads. For this type of web, stitchbonding machines of the “Maliwatt” type from Karl Mayer, formerly Malimo, are known. And then the Caliweb® is outstandingly suitable. The Caliweb® consists of a thermally fixed Multiknit spacer web with two outer mesh layers and an inner pile layer arranged perpendicular to the mesh layers.

According to one particularly advantageous embodiment of the invention, the nonwoven chosen for the outer layer B is a needle felt web, preferably having a basis weight of 40 to 250 g/m², more preferably having a basis weight of 80 to 150 g/m². According to a further advantageous development, the stitchbonded nonwoven of outer layer A has a basis weight of 60 to 300 g/m², more particularly of 150 to 200 g/m².

Starting materials envisaged for the outer layers are, in particular polyester, polypropylene, viscose or cotton fibers. The present invention, however, is not restricted to the materials stated; instead, it is possible to use a large number of other fibers to produce the web, this being evident to the skilled worker without any need for inventive activity. Wear-resistant polymers such as polyesters, polyolefins, polyamides or glass fibers or carbon fibers are used in particular.

In order to produce a self-adhesive tape from the backing, or for the viscoelastic adhesive of the interlayer C, it is possible to have recourse to all known adhesive systems. Besides natural or synthetic rubber-based adhesives it is possible to use silicone adhesives and also polyacrylate adhesives. On account of their particular suitability, as the adhesive for wrapping tapes for automobile cable looms, with respect to the absence of fogging and also the outstanding compatibility with both PVC and PVC-free core insulation, preference is given to solvent-free acrylate hotmelts, as described in more detail in DE 198 07 752 A1 and also in DE 100 11 788 A1.

As the coating technology, known systems come into play, with appropriate processes being those which allow adhesives of high viscosity to be applied without pressure, such as the nozzle coating of hotmelt adhesives, for example, or their application by transfer from an anti-adhesive carrier cloth or release liner to the backing assembly.

A suitable adhesive is one based on acrylate hotmelt with a K value of at least 20, more particularly greater than 30 (measured in each case in 1% strength by weight of solution in toluene, 25° C.), obtainable by concentrating a solution of such an adhesive to give a system which can be processed as a hotmelt. Concentration may take place in appropriately equipped tanks or extruders; more particularly in the case of accompanying devolatilization, a devolatilizing extruder is preferred. One such adhesive is set out in DE 43 13 008 C2. In an intermediate step, the solvent is removed completely from the acrylate adhesives prepared in this way. The K value is determined more particularly in analogy to DIN 53 726.

Additionally, in the course of this procedure, further volatile constituents are removed. After coating from the melt, these adhesives have only small residual fractions of volatile constituents. Accordingly, it is possible to take on all of the monomers/formulas that are claimed in the patent cited above. The solution of the adhesive may contain 5 to 80% by weight, more particularly 30 to 70% by weight, of solvent. Preference is given to using commercially available solvents, more particularly low-boiling hydrocarbons, ketones, alcohols and/or esters. Further preference is given to using single-screw, twin-screw or multi-screw extruders having one or, more particularly two or more devolatilizing units. The acrylate hotmelt-based adhesive can have benzoin derivatives incorporated into it by copolymerization: for example benzoin acrylate or benzoin methacrylate, acrylic or methacrylic esters. Benzoin derivatives of this kind are described in EP 0 578 151 A. The acrylate hotmelt-based adhesive may be UV-crosslinked. Other types of crosslinking are also possible, however, an example being electron beam crosslinking. In a further preferred embodiment, the self-adhesives employed are copolymers or (meth)acrylic acid and the esters thereof having 1 to 25 C atoms, maleic, fumaric and/or itaconic acid and/or their esters, substituted (meth)acrylamides, maleic anhydride and other vinyl compounds, such as vinyl esters, more particularly vinyl acetate, vinyl alcohols and/or vinyl ethers. The residual solvent content ought to be below 1% by weight.

One adhesive, which is found to be particularly suitable is a low molecular mass, pressure-sensitive acrylate hotmelt adhesive of the kind carried under the name acResin UV or Acronal®, especially acResin 258UV, by BASF. This adhesive with a low K value acquires its application-compatible properties through a concluding, radiation-induced crosslinking operation.

On the adhesive coating of the backing there may be at least one stripe of a covering, extending in the longitudinal direction of the adhesive tape and covering between 20% and 90% of the adhesive coating.

According to one preferred embodiment of the invention precisely one stripe of the covering is present on the adhesive coating.

The position of the stripe on the adhesive coating is freely selectable, with an arrangement directly at one of the longitudinal edges of the backing being preferred. In this way an adhesive stripe is produced which extends in the longitudinal direction of the adhesive tape and finishes at the other longitudinal edge of the backing. Where the adhesive tape is used to wrap a cable harness, by the adhesive tape being guided in a helicoidal movement around the cable harness, the jacketing of the cable loom can be accomplished by adhering the adhesive of the adhesive tape only to the adhesive tape itself, with the product not coming into contact with any adhesive. The cable loom wrapped in this way enjoys very high flexibility as a result of the absence of the fixing of the cable by any adhesive. Consequently, its flexibility on installation—particularly in narrow passages or sharp bends—is significantly increased.

If a certain degree of fixing of the adhesive tape on the product is desired, then wrapping can also be accomplished by adhering part of the adhesive stripe to the adhesive tape itself and another part to the product.

According to another advantageous embodiment the stripe is applied centrally on the adhesive coating, thereby producing two adhesive stripes extending on the longitudinal edges of the backing in the longitudinal direction of the adhesive tapes. For the secure and economic application of the adhesive tape in the said helicoidal movement around the cable harness and to counter the slipping of the resultant protective jacketing, the two adhesive stripes each present on the longitudinal edges of the adhesive tape are advantageous, particularly if one, which is usually narrower than the second stripe, serves as a fixing aid and the second, broader stripe serves as a fastener. In this way, the adhesive tape is bonded to the cable in such a way that the cable harness is secured against slipping but is nevertheless of flexible design.

In addition there are embodiments in which more than one stripe of the covering is applied to the adhesive coating. When reference is made only to one stripe, the skilled person reads this, conceptually, as accommodating the possibility that two or more stripes may at the same time cover the adhesive coating.

The stripe preferably covers a total of between 50% and 80% of the adhesive coating. The degree of coverage is selected as a function of the application and of the diameter of the cable harness.

With particular preference there remain one or two adhesive stripes, whose total width accounts for 20 to 50% of the width of the backing.

Particularly if the adhesive coating is not a full-area coating but instead is, for example, in stripe form, the stated percentages refer to the width of the stripes of the covering in relation to the width of the backing; in other words, in accordance with the invention, the stripe or stripes of the covering have a width which accounts for between 20% and 90% of the width of the backing.

Suitable materials for the covering include the typical films used especially for cable bandaging applications, based on polyolefins (for example polyethylene films, polypropylene films, monoaxially or biaxially oriented polypropylene films, polyester films, PA films, and other films) or PVC preferably those having plasticizer contents of between 20 and 60 phr.

The outer layers and/or the adhesive coating may additionally have been made flame retardant by means, for example, of a flame retardant composed of ammonium polyphosphate, magnesium hydroxide and/or aluminium hydroxide, or using a chlorinated paraffin, where appropriate in combination with antimony trioxide. The flame retardants may also be organic bromine compounds, where necessary with synergists such as antimony trioxide, although, with a view to the absence of halogen to the adhesive tape, preference is given to using red phosphorus, organophosphorous compounds, mineral compounds or intumescent compounds such as ammonium polyphosphate, alone or in conjunction with synergists.

In one particularly preferred variant of the tape of the invention, its construction is as follows:
the outer layer A is composed of a stitchbonded nonwoven with 60 to 300 g/m²,
the outer layer B is composed of a needle felt web with 40 to 250 g/m², and
the interlayer C is composed of a polyester film 10 to 70 μm, preferably 12 to 50 μm thick which is coated on both sides with polyacrylate adhesive, the coat weights of the polyacrylate adhesive being in each case 20 to 200 g/m², more particularly 80 to 120 g/m².

The adhesive tape may preferably have an abrasion resistance to LV 312 (January 2006 edition), whereby a number of strokes of more than 5000, preferably more than 16 000, are withstood.

The adhesive tape may then have a noise suppressant LV 312 (January 2006 edition) of more than 10 dB (A), in particular more than 15 dB (A).

In order to optimize the dispensing of the adhesive tape, in one preferred embodiment of the invention, there are weakening lines which extend over the entire width of the adhesive tape. In order particularly to simplify operation for the user, the weakening lines are aligned at right angles to the running direction of the adhesive tape and/or are disposed at regular intervals. The adhesive tape is therefore hand-tearable in transverse direction. A further improvement in the context of the use of the adhesive tape can be achieved if the adhesive tape is severed completely, preferably at regular intervals, and applied in the form of what are called “kiss-cut diecuts” to release paper. In this way the individual diecuts can be dispensed selectively through the use of a dispenser. The weakening lines are preferably configured in the form of perforations. In this way it is possible to obtain edges between the individual sections that are highly lint-free, thus preventing unwanted fraying. The weakening lines can be produced in a particularly advantageous way either discontinuously, using flat dies or cross-running perforating wheels or continuously, using rotary systems such as spiked rollers or punch rollers, with or without the use of a counter-roller (Vulkollan roller) forming the counter wheel during cutting. Further possibilities include cutting technologies which are controlled to operate intermittently, such as the use of lasers, ultrasound, high-pressure water jets, for example. Where, in the case of laser or ultrasound cutting, some of the energy is introduced into the material in the form of heat, it is possible to melt the material in the area of cutting, thereby very largely preventing disruptive fraying, and giving sharply contoured cut edges. Latter methods are also suitable for obtaining specific cut edge geometries such as concave or convex cut edges, for example. The height of the spikes or blades on the punch rollers is preferably 150% of the thickness of the adhesive tape. The hole/bridge ratio in the case of perforation—that is, the ratio of the number of millimeters where the material holds together (“bridge”) to the number of millimeters over which it is severed—determines how easily the adhesive tape is to tear. Furthermore, this ratio also ultimately influences the extent to which the torn edge is lint-free. The bridge width is preferably approximately 2 mm and the cut width between the bridges is preferably approximately 5 mm: in other words, bridges 2 mm wide alternate with incisions 5 mm long. The hole/bridge ratio accordingly is preferably 2:5. With this weakening of the material it is possible to achieve a sufficiently low tearing force.

The adhesive tape is preferably used for wrapping elongated products such as, in particular, cable looms, the elongated product being wrapped in the axial direction by the adhesive tape, or the adhesive tape being guided in a helicoidal spiral around the elongated product.

Also embraced by the concept of the invention finally, is an elongated product such as, more particularly, a cable loom, wrapped with the adhesive tape of the invention, and also a vehicle comprising an inventively wrapped cable harness.

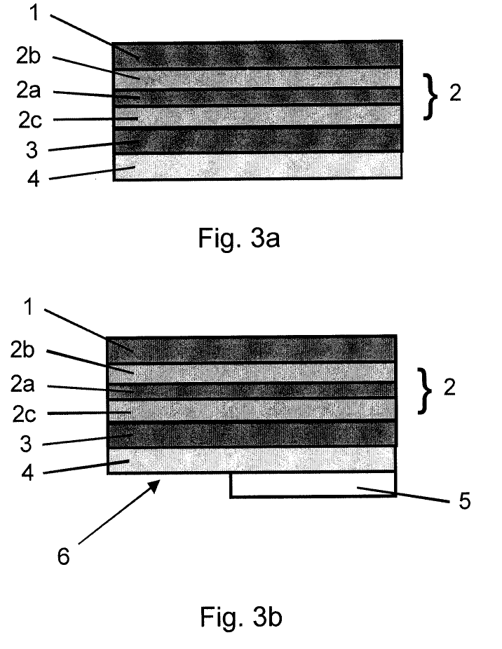

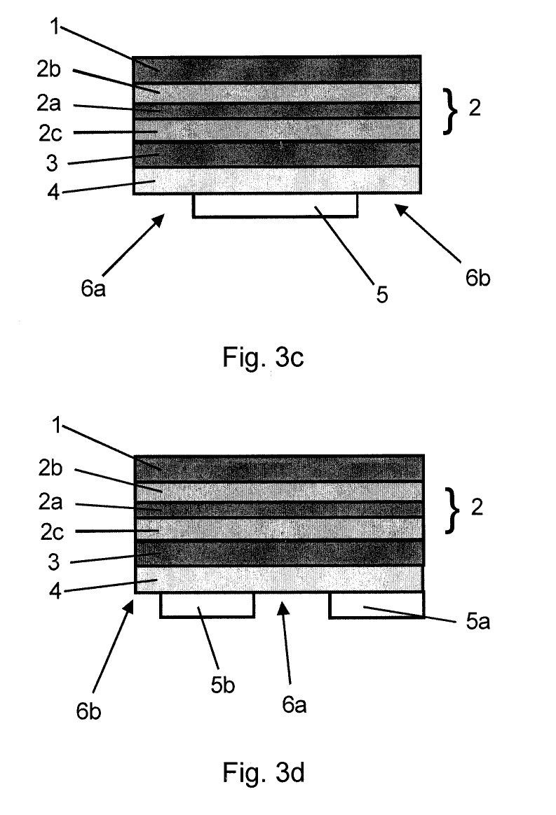

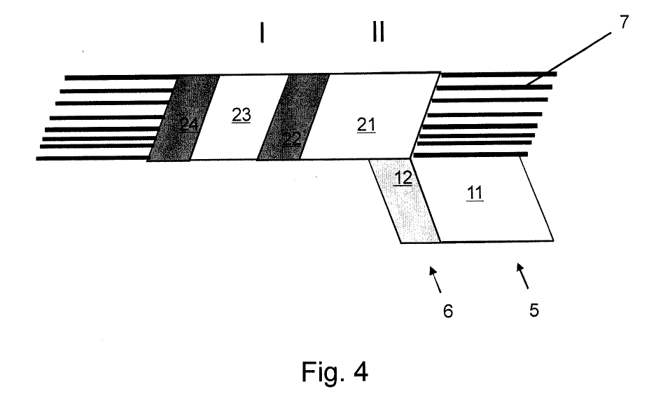

With reference to the FIGS. 3a-3d and 4 described below, the adhesive tape of the invention is elucidated in more detail in one particularly advantageous embodiment, without any wish that the invention should thereby be restricted.

FIG. 3a shows the self-adhesive tape of the invention in side-on section.

The outer layer A (1) is composed of a stitchbonded nonwoven with 60 to 300 g/m²; the outer layer B (3) is composed of a needle felt web with 40 to 250 g/m². Between the two webs is the interlayer C (2), which consists of a polyester film (2a) 25 μm thick and coated on either side With polyacrylate adhesive (2b, 2c), the coat weights of the polyacrylate adhesive (2b, 2c) being in each case 80 g/m².

Applied to the outer layer B (3) is a pressure-sensitive adhesive coating (4).

In accordance with FIG. 3b, which shows the self-adhesive tape of the invention as per FIG. 3a in a side-on section, there is precisely one stripe (5) of the covering present on the adhesive coating (4), specifically in such a way that the stripe (5) lies directly on one of the longitudinal edges of the backing. This produces an adhesive stripe (6) which extends in the longitudinal direction of the tape.

In FIG. 3c the stripe (5) is applied centrally on the adhesive coating (4), and so there are two adhesive stripes (6a, 6b) extending at the edges of the backing in the longitudinal direction of the adhesive tape.

In FIG. 3d there are two stripes (5a, 5b) applied on the adhesive coating (3), and so there are two adhesive stripes (6a, 6b) extending at the edges of the backing in the longitudinal direction of the adhesive tape.

FIG. 4 shows a section of a cable harness which is composed of a bundle of individual cables (7) and which is wrapped with the adhesive tape of the invention. The adhesive tape is guided in a helicoidal movement around the cable harness. The section of the cable harness that is shown has two winds I and II of the adhesive tape. Further winds would extend towards the left; these are not shown here. On the adhesive coating (4) is a stripe (5) of the covering, and so there is an adhesive stripe (6) extending in the longitudinal direction of the tape. Non-adhesive areas (11, 21, 23) of the adhesive tape alternate with adhesive areas (12, 22, 24). (Sections 22 and 24 are not visible from the outside, in contrast to the exposed adhesive 12, and this is why the denser shading has been selected to depict them.) The cable harness is wrapped in such a way that the stripe (6) of adhesive adheres fully to the adhesive tape. Sticking to the cables (7) is not an option.

Surprisingly, and unexpectedly to the skilled person, the adhesive tape of the invention exhibits outstanding abrasion resistance and a high level of noise suppression.

This is also shown by the following comparative measurements.

For these measurements, a self-adhesive tape of the invention is compared with a pure PET-film and also with an adhesive tape whose two outer layers are joined to one another only by an adhesive and not by a PET film, coated with adhesives on both sides.

The materials selected were as follows:

### COMPARATIVE EXAMPLE 1

25 μm PET film

### COMPARATIVE EXAMPLE 2

Stitchbonded nonwoven (190 g/m²)
Polyacrylate adhesive (80 g/m²)
Polyester needle felt web (100 g/m²)
Polyacrylate adhesive (80 g/m²)

### INVENTIVE EXAMPLE 3

Stitchbonded nonwoven (190 g/m²)
Polyacrylate adhesive (80 g/m²)
PET film (25 μm)
Polyacrylate adhesive (50 g/m²)
PET needle felt web (100 g/m²)
Polyacrylate adhesive (80 g/m²)

### COMPARATIVE EXAMPLE 4

Stitchbonded nonwoven (190 g/m²)
Polyacrylate adhesive (80 g/m²)
Stitchbonded nonwoven web (190 g/m²)
Polyacrylate adhesive (80 g/m²)

### INVENTIVE EXAMPLE 5

Stitchbonded nonwoven (190 g/m²)
Polyacrylate adhesive (80 g/m²)
PET film (25 μm)
Polyacrylate adhesive (50 g/m²)
Stitchbonded nonwoven web (190 g/m²)
Polyacrylate adhesive (80 g/m²)

The stitchbonded nonwoven is a web of the Maliwatt type, consisting of PET fibers with a length of 76 mm and a thickness of 3 dtex, and of a PET stitching thread with a linear density of 75 dtex with a total basis weight of 190 g/m². The polyacrylate adhesive used is the adhesive acResin 258UV from BASF, an UV-crosslinked acrylate hotmelt.

### Results

Abrasion resistance and damping properties according to LV 312:

The abrasion resistance of the tape can be improved significantly by means of the interlayer of the invention:

| | Abrasion value | Abrasion value | Damping |
|---|---|---|---|
| | 10 mm | 5 mm | value |
| Example | Strokes | Strokes | dB (A) |
| Comparative example 1 | 500 | 200 | 1 |
| Comparative example 2 | 5888 | 3320 | 15 |
| Inventive example 3 | 11 464 | 5470 | 15 |
| Comparative example 4 | 7183 | | 15 |
| Inventive example 5 | 13 220 | | 15 |

The construction of the tape has an effect on the damping of sound with particular advantage. At the same time the noise suppression requirements from OEM specifications such as LV 312 are met.

The interlayer with the film-based backing, furthermore, also represents a barrier layer for, for example, chemicals and service fluids, such that saturation of the backing is reliably prevented.

What is claimed is:

1. A noise-suppressing and highly abrasion-resistant tape comprising a backing which is composed at least of three layers, specifically
a first outer layer A,
a second outer layer B,
an interlayer C, which is located between outer layers A and B and is firmly connected at least in sections to the outer layers A and B,
wherein
the outer layer A is composed of a stitchbonded nonwoven,
the outer layer B is composed of a nonwoven, and
the interlayer C is composed of a film which is coated on both sides with a viscoelastic adhesive.

2. Tape according to claim 1, which comprises an adhesive coating applied on the backing on at least one side.

3. Tape according to claim 2, wherein the adhesive coating is a self-adhesive coating.

4. Tape according to claim 1, wherein the film in the interlayer C is composed of one or more polymers selected from the group consisting of PVC, polyethylene, polypropylene, polyester, polyurethane and polyamide.

5. Tape according to claim 1, wherein the film in the interlayer C has a thickness of 5 to 150 μm.

6. Tape according to claim 1, wherein the viscoelastic adhesive on the double-sidedly coated film is a self-adhesive based on natural rubber, polyacrylates, synthetic rubber or silicones.

7. Tape according to claim 1, wherein the outer layer B nonwoven is a staple fiber web or a spunbonded web, the web being consolidated by water jets or air jets, by mechanical needling or thermal treatment.

8. Tape according to claim 1, wherein the outer layer B nonwoven is a needle felt web.

9. Tape according to claim 1, wherein the outer layer A stitchbonded nonwoven has a basis weight of 60 to 300 g/m².

10. Tape according to claim 1,
wherein
the outer layer A is composed of a stitchbonded nonwoven with 60 to 300 g/m²,
the outer layer B is composed of a needle felt web with 40 to 250 g/m², and
the interlayer C is composed of a polyester film 12 to 50 μm thick which is coated on both sides with polyacrylate adhesive, the coat weights of the polyacrylate adhesive being in each case 20 to 200 g/m².

11. Tape according to claim 1, which has an abrasion resistance to LV 312 (January 2006 edition), whereby a number of strokes of more than 5000 are withstood.

12. Tape according to claim 1, which has a noise suppressant LV 312 (January 2006 edition) of more than 10 dB (A).

13. A method for wrapping an elongated product comprising wrapping the elongated product with a tape according to claim 1, the elongated product being wrapped in an axial direction by the tape, or the tape being led in a helicoidal spiral around the elongated product.

14. An elongated product wrapped with a tape according to claim 1.

15. The elongated product according to claim 14, which is a cable harness.

16. A vehicle comprising a cable harness according to claim 15.
